(19) United States
(12) Patent Application Publication
(10) Pub. No.: US 2026/0326006 A1
(43) Pub. Date: Oct. 22, 2026

(54) FILTER ASSEMBLY AND MANUFACTURING METHOD THEREOF

(71) Applicants: Hyundai Motor Company, Seoul (KR); Kia Corporation, Seoul (KR); Freudenberg Vilene Filtration Technologies Korea Co., Ltd., Pyeongtaek-si (KR)

(72) Inventors: Gun Woo NAM, Hwaseong-Si (KR); Dong Kwan KIM, Pyeongtaek-si (KR); Byung Yeon PARK, Pyeongtaek-si (KR)

(21) Appl. No.: 19/351,897

(22) Filed: Oct. 7, 2025

(30) Foreign Application Priority Data
Apr. 18, 2025 (KR) 10-2025-0050952

(51) Int. Cl. B01D 46/00; B01D 46/52; B01D 46/62

(52) U.S. Cl. CPC B01D 46/0005; B01D 46/0001; B01D 46/521; B01D 46/62; B01D 2265/06; B01D 2267/40

(57) ABSTRACT

A filter assembly may be configured to reliably fix, using a plurality of filter supports, a main filter configured to substantially filter out various types of contaminants, thereby preventing occurrence of a local pressure difference in a filter, enabling a constant flow of air passing through the filter, and improving performance of the filter configured to collect the various types of contaminants. The filter assembly may be manufactures/assembled by a manufacturing method.

### CROSS-REFERENCE TO RELATED APPLICATION

This application claims, under 35 U.S.C. § 119(a), the benefit of priority from Korean Patent Application No. 10-2025-0050952, filed on Apr. 18, 2025, the entire contents of which are incorporated herein by reference.

### TECHNICAL FIELD

The present disclosure relates to a filter assembly and a manufacturing method thereof, and more particularly, to a filter assembly capable of filtering various types of dust and paint aerosols in a painting process, and a manufacturing method of the filter assembly.

### BACKGROUND

A paper filter may filter out various types of dust and paint aerosols and may be installed in a painting booth serving as one of the facilities to paint a vehicle body.

If the paper filter is installed in an exhaust duct of the painting booth, various types of dust contained in the air exhausted from the painting booth to the outside and various types of paint aerosols generated during painting work may be filtered by the paper filter.

However, the paper filter adapted to filter out various types of dust and paint aerosols may not be firmly fixed, so a local differential pressure (a pressure difference between the inside of the painting booth and the outside thereof) occurs in the paper filter. As a result, there may be a problem in that a flow of air passing through the paper filter is not constantly maintained.

The interrupted flow of air passing through the paper filter may cause deterioration in performance of the paper filter in collecting/filtering various types of dust and paint aerosols.

If various types of dust and paint aerosols are significantly accumulated on the lower portion of the paper filter (e.g., after being filtered by the paper filter), filtering performance of the paper filter may deteriorate and a lifespan thereof may be shortened.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The following summary presents a simplified summary of certain features. The summary is not an extensive overview and is not intended to identify key or critical elements.

Systems, apparatuses/devices, and methods are described for a filter assembly. A filter assembly may comprise a main filter forming a plurality of first open grooves formed to face a first direction and a plurality of second open grooves formed to face a second direction opposite to the first direction, the first open grooves and the second open grooves being alternately arranged; a plurality of first filter supports, wherein each first filter support of the plurality of first filter supports is disposed in a corresponding one of the first open grooves and comprises a plurality of first support wings configured to support a first surface of the main filter; a plurality of second filter supports, wherein each second filter support of the plurality of second filter supports is disposed in a corresponding one of the second open grooves and comprises a plurality of second support wings configured to support a second surface of the main filter; and a filter case, forming an air inlet and an air outlet, the filter case being configured to cover upper and lower portions of: the main filter, the first filter support, and the second filter support.

A method of providing a filter assembly may comprise: providing a filter case that forms an air inlet and an air outlet; providing a plurality of first filter supports, wherein each first filter support of the plurality of first filter supports comprises a plurality of first support wings and a plurality of first holding wings configured to support the plurality of first support wings; providing a plurality of second filter supports, wherein each second filter support of the plurality of second filter supports comprises a plurality of second support wings and a plurality of second holding wings configured to support the plurality of second support wings; winding a first part of a length section of a main filter around first ends, of the plurality of first filter supports, in a first direction, such that the first support wings support the first part of the length section; winding a second part of the length section of the main filter around second ends, of the plurality of second filter supports, in a second direction opposite to the first direction, such that the second support wings support the second part of the length section; and inserting the main filter, wound around the first filter support and the second filter support, into the filter case, such that the filter case covers upper and lower portions of: the main filter, the first filter support, and the second filter support.

These and other features and advantages are described in greater detail below.

### BRIEF DESCRIPTION OF THE DRAWINGS

The above and other features of the present disclosure will now be described in detail with reference to certain examples thereof illustrated in the accompanying drawings which are given hereinbelow by way of illustration only, and thus are not limitative of the present disclosure, and wherein:

FIG. 1 is an exploded perspective view of a filter assembly according to the present disclosure;

FIG. 2 is a perspective view showing a state in which a main filter of the filter assembly according to the present disclosure is assembled with a first filter support and a second filter support;

FIG. 3 is a plan view showing the state in which the main filter of the filter assembly according to the present disclosure is assembled with the first filter support and the second filter support;

FIGS. 4 and 5 are assembly perspective views each showing the filter assembly according to the present disclosure;

FIG. 6 is a schematic view showing a state in which the filter assembly according to the present disclosure is disposed inside a duct having a circular ring shape;

FIGS. 7, 8, and 9 are perspective views sequentially showing a process of manufacturing the first filter support of the filter assembly according to the present disclosure; and

FIGS. 10, 11, and 12 are perspective views sequentially showing a process of manufacturing the second filter support of the filter assembly according to the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, reference will be made in detail to various examples of the present disclosure, examples of which are illustrated in the accompanying drawings and described below. Specific structural or functional descriptions given in connection with the examples of the present disclosure are merely illustrative for the purpose of describing examples according to the concept of the present disclosure, and the examples according to the concept of the present disclosure may be implemented in various forms. Further, it will be understood that the present description is not intended to limit the disclosure to the examples. On the contrary, the disclosure is intended to cover not only the examples, but also various alternatives, modifications, equivalents, and other examples, which may be included within the spirit and scope of the disclosure as defined by the appended claims.

In the present disclosure, terms such as “first” and/or “second” may be used to describe various components, but the components are not limited by the terms. The terms are used only for the purpose of distinguishing one component from other components. For example, a first component may be referred to as a second component, and similarly, a second component may also be referred to as a first component without departing from the scope of rights according to the concept of the present disclosure.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that other components are not present therebetween. Other expressions for the description of relationships between components, that is, “between” and “directly between” or “adjacent to” and “directly adjacent to”, should be interpreted in the same manner.

The same reference numerals represent the same components throughout the specification. Additionally, the terms in the specification are used merely to describe examples and are not intended to limit the present disclosure. In this specification, an expression in a singular form also includes a plural form, unless clearly specified otherwise in context. As used herein, expressions such as “comprise” and/or “comprising” do not exclude the presence or addition of one or more components, steps, operations, and/or elements other than those described.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, as well as unmanned (e.g., autonomous) vehicles. The “vehicle” herein may comprise include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle may be a vehicle that has/is configured to user two or more sources of power, for example, vehicles powered by both gasoline and electricity.

Hereinafter, the present disclosure will be described in detail with reference to the accompanying drawings.

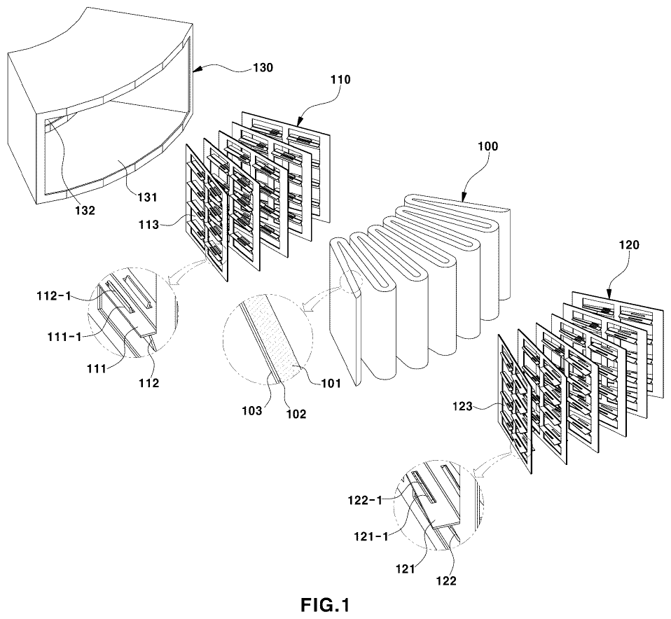

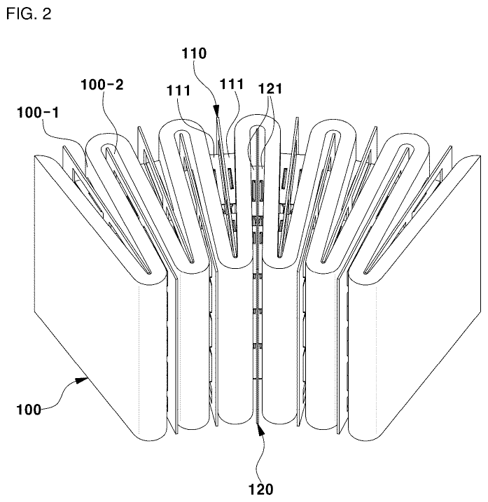

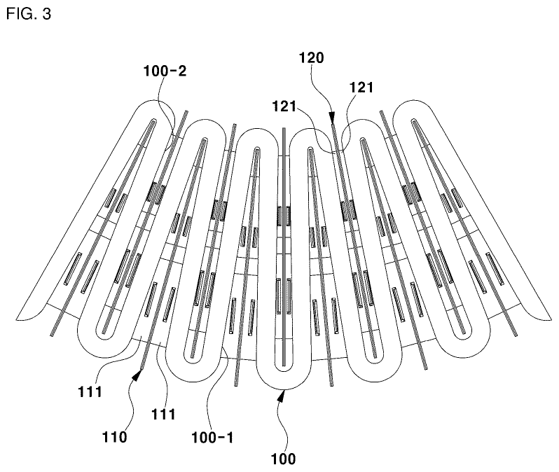

FIG. 1 is an exploded perspective view of a filter assembly according to the present disclosure, FIG. 2 is a perspective view showing a state in which a main filter of the filter assembly according to the present disclosure is assembled with a first filter support and a second filter support, and FIG. 3 is a plan view showing the state in which the main filter of the filter assembly according to the present disclosure is assembled with the first filter support and the second filter support.

As shown in FIGS. 1, 2, and 3, the filter assembly according to the present disclosure includes a main filter 100, a first filter support 110, a second filter support 120, and a filter case 130.

The main filter 100, the first filter support 110, the second filter support 120, and the filter case 130 forming the filter assembly may be made of a material (e.g., a paper material) useful for adsorbing and/or filtering paint aerosols. Also, or alternatively, the main filter 100, the first filter support 110, the second filter support 120, and the filter case 130 may be manufactured using a synthetic resin such as a nonwoven fabric capable of adsorbing and/or filtering paint aerosols.

As shown in a partial cross-section in FIG. 2, the main filter 100 may be formed in such a manner that a first-stage filter 101, a second-stage filter 102, and a third-stage filter 103 having different mesh sizes may be sequentially stacked on and attached to each other, and may have flexibility for bending and zigzag arrangement.

As shown in FIGS. 2 and 3, the main filter 100 may be arranged in a zigzag pattern such that a part of the length section of the main filter 100 is repeatedly wound around the outer ends (e.g., first ends) of the plurality of first filter supports 110 (e.g., first ends of the plurality of first filter supports 100 in a first direction). Other parts of the length section of the main filter 100 may be repeatedly wound around the inner ends (e.g., second ends) of the plurality of second filter supports 120 (e.g., second ends of the plurality of second filter supports 120 in a second direction opposite to the first direction). The main filter 100 may have a first side substantially normal to the first direction, and a second side substantially normal to the second direction. The first direction may be an outward radial direction of the main filter 100, in the case that the main filter is arranged to have an arc shape. The second direction may be an inward radial direction if the first direction is an outward radial direction. “Outer” herein may refer to the first direction and/or outer radial direction and “inner” herein may refer to the second direction and/or inner radial direction.

When/if the main filter 100 is in close (e.g., direct) contact with the first filter support 110 and the second filter support 120 and forms the zigzag arrangement, as described herein (e.g., when/if the main filter 100 is supported by the first filter support 110 and the second filter support 120 so as to be arranged in a zigzag pattern), a plurality of first open grooves 100-1 may be formed that open toward the first direction (e.g. toward air to be filtered, such as an inside of a source of air to be filtered, such as a painting booth). Also, a plurality of second open grooves 100-2 may be formed that open toward the second direction (e.g., away from the air to be filtered, such as outside the source of air to be filtered, such as an exhaust port of an exhaust duct communicating with outside air).

The first filter support 110 may form a plurality of first support wings 111 adapted (e.g., configured) to closely support (e.g., physically support, structurally support, directly support, etc.) the inner surface of the main filter 100 (e.g., in a state of being inserted into the first open grooves 100-1 in the main filter 100).

The first support wings 111 may be respectively formed on both side surfaces of the first filter support 110 in a diagonal wing shape (e.g., wider toward the first end of the first filter support 110 in the first direction, narrower toward a second end of the first filter support 110 in the second direction) so as to support the main filter 100 in a fan-shaped arrangement state.

The first support wings 111 may be formed to be integrated with both side surfaces of the first filter support 110. The first support wings 111 may be arranged horizontally (e.g., substantially perpendicular to the first filter support 110 and extending in the first-second direction). Each of the first support wings 111 may have a width that (e.g., gradually) narrows from the air inlet side (e.g., first side towards the first direction) toward the air outlet side (second side towards the second direction), thereby allowing the ends of the first support wings 111 to closely (e.g., directly) support an inner wall surface of the first open grooves 100-1, which may be a part of an inner surface of the main filter 100.

Each of the first open grooves 100-1 in the main filter 100 may be formed to have a “V” shape open at a predetermined angle toward the first direction (for example, the painting booth) by the first support wings 111, each having a width that gradually narrows from the air inlet side (e.g., first side) toward the air outlet side (e.g., second side). In this manner, the main filter 100 may be arranged in a zigzag pattern and may form a fan shape (an arc wider on the first side than the second side).

First holding wings 112 may be respectively further formed on both side surfaces of the first filter support 110 and may be respectively disposed below the first support wings 111 so as to hold the respective first support wings 111 in the horizontal state. Each of the first support wings 111 may have a first coupling hole 111-1 formed therein. Each of the first holding wings 112 may have a first holding protrusion 112-1 formed thereon.

The first holding protrusion 112-1 of the first holding wing 112 may be inserted into and coupled to the first coupling hole 111-1 in the first support wing 111. In this manner, the first support wings 111 may be fixed in the horizontal arrangement in a state of being supported by the respective first holding wings 112.

A plurality of inflow air flow holes 113 may be formed at upper positions of the first support wings 111 of the first filter support 110 and lower positions of the first holding wings 112 of the first filter support 110. If/when air to be filtered (e.g., internal air, such as the internal air of the painting booth, which contains dust and paint aerosols) is introduced into the first open grooves 100-1 in the main filter 100, the internal air may filterably flow to the inner wall surfaces on both sides of the first open grooves 100-1 through the inflow air flow holes 113 in the first filter support 110.

The second filter support 120 may form a plurality of second support wings 121, which may be adapted to closely support the outer surface of the main filter 100 (e.g., in a state of being inserted into a second open groove 100-2 in the main filter 100).

The second support wings 121 are respectively formed to be integrated with both side surfaces of the second filter support 120 so as to support the main filter 100 in a fan-shaped arrangement state, and each of the second support wings 21 is formed to have a constant width.

The second support wings 121 each having a constant width may be integrated with both side surfaces of the second filter support 120. The second support wings 121 may be arranged horizontally, thereby allowing the ends of the second support wings 121 to closely support the inner wall surface of the second open grooves 100-2, which may be a part of the outer surface of the main filter 100.

Each of the second open grooves 100-2 in the main filter 100 may have a constant width based on the second support wings 121 each having a constant width. In this manner, the main filter 100 may be arranged in a zigzag pattern and may form a fan shape.

Second holding wings 122 may be respectively formed on both side surfaces of the second filter support 120. The second holding wings 122 may be respectively disposed below the second support wings 121, so as to hold the respective second support wings 121 in a horizontal state. Each of the second support wings 121 may have a second coupling hole 121-1 formed therein, and each of the second holding wings 122 may have a second holding protrusion 122-1 formed thereon.

The second holding protrusion 122-1 of the second holding wing 122 may be inserted into and coupled to the second coupling hole 121-1 in the second support wing 121. In this manner, the second support wings 121 may be fixed in the horizontal arrangement in a state of being supported by the respective second holding wings 122.

A plurality of exhaust air flow holes 123 may be formed at the upper positions of the second support wings 121 of the second filter support 120 and/or the lower positions of the second holding wings 122. If/when air to be filtered (e.g., comprising dust and paint aerosols to be filtered) passes through the main filter 100 via the first open grooves 100-1 and is discharged to the second open grooves 100-2, the air may be easily exhausted to the exhaust port of the exhaust duct through the exhaust air flow holes 123 in the second filter support 120.

The filter case 130 may have an air inlet 131 formed in an outer diameter portion thereof (e.g., facing the first direction) and an air outlet 132 formed in the inner diameter portion thereof (e.g., facing the second direction). The filter case may be manufactured to cover the upper and lower portions of the main filter 100, the first filter support 110, and the second filter support 120.

The filter case 130 may be manufactured in a fan shape in which an arc length of the outer diameter portion having the air inlet 131 formed therein is larger than an arc length of the inner diameter portion having the air outlet 132 formed therein.

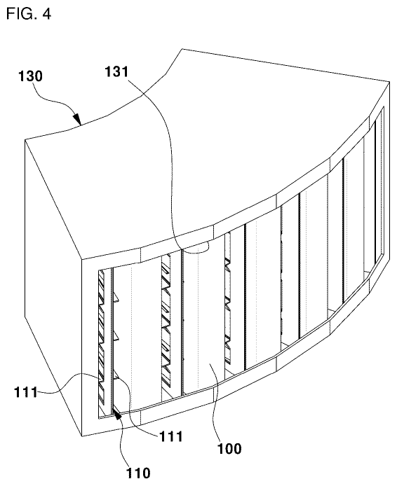

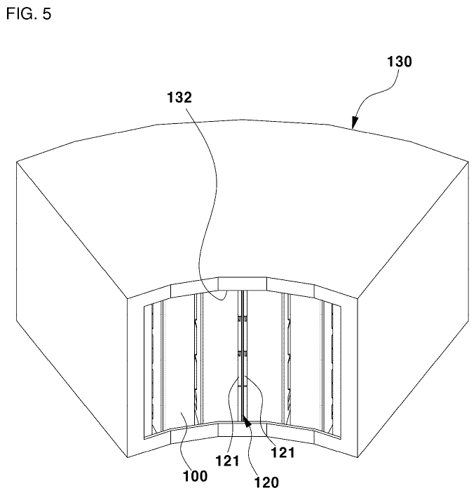

If/when the main filter 100, the first filter support 110, and the second filter support 120 are fixedly inserted into the inside of the filter case 130 (e.g., as disclosed herein), the upper and lower portions of the main filter 100, the first filter support 110, and the second filter support 120 may be covered. Further, as shown in FIG. 4, the first open grooves 100-1 in the main filter 100 may be exposed through/via the air inlet 131. As shown in FIG. 5, the second open grooves 100-2 in the main filter 100 may be exposed through/via the air outlet 132.

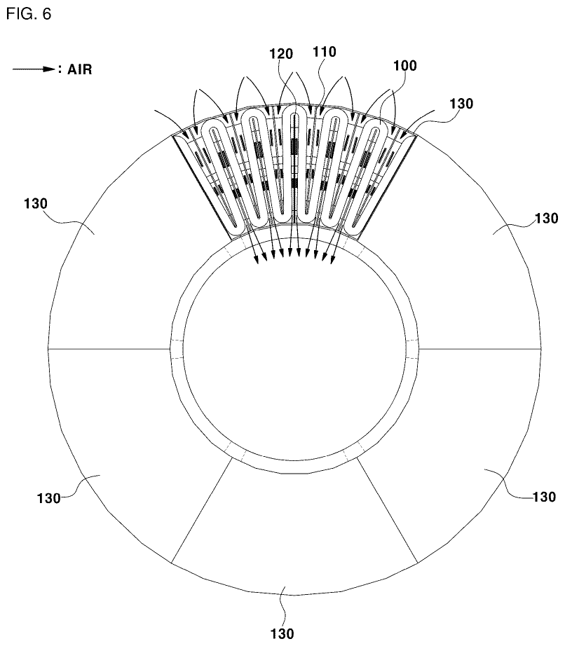

If/since the filter case 130 is manufactured in a fan shape, e.g., as shown in FIG. 6, a plurality of the filter cases 130 may be arranged (e.g., in a stacked manner) in the circumferential direction, such as around a circular ring-shaped exhaust duct 140 (e.g., disposed inside the painting booth). For example, the circular ring-shaped exhaust duct 140 having an exhaust port 141 may be formed in the central portion of the plurality of filter cases 130.

The air to be filtered (e.g., internal air of the painting booth, which contains dust and paint aerosols) may be introduced into the inner surface of the main filter 100 through/via the air inlet 131 of the filter case 130. The air to be filtered may thereby be introduced into the first open grooves 100-1. If/when the introduced air passes through the inner surface of the main filter 100 and the inner wall surfaces on both sides of the first open groove 100-1, the air may be filtered (e.g., the dust and paint aerosols may be filtered out).

Filtered air may pass through the main filter 100 and may be discharged from the outer surface of the main filter 100 and the inner wall surface of the second open groove 100-2 to the exhaust duct 140. The air may be discharged (e.g., to the outside) through/via the exhaust port 141 of the exhaust duct 140.

### Various Types of Contaminants (e.g., Dust and Paint Aerosols) May Be Filtered

by the main filter 100. The various types of contaminants may become evenly distributed and accumulated on the first support wings 111 of the first filter support 110 and the second support wings 121 of the second filter support 120, due to the structure of the main filter 100 disclosed herein. Th even distribution and/or accumulation of the contaminants on the first support wings 111 and the second support wings 121 may prevent the various types of contaminants from being significantly dropped and/or accumulated on the lower portion of the paper filter. As a result, filtering performance of the paper filter may be maintained and the life of the paper filter may be extended.

As described herein, the main filter 100 is arranged in a zigzag pattern using the first filter support 110 and the second filter support 120, the first support wings 111 of the first filter support 110 may closely support the inner surface of the main filter 100, and the second support wings 121 of the second filter support 120 may closely support the outer surface of the main filter 100. As such, the main filter 100, configured to substantially filter out various types of contaminants, may be reliably/stably fixed (e.g., in shape/structure). Accordingly, a constant flow of air passing through the main filter 100 may be secured, and performance of the main filter 100 may be improved/maintained.

A manufacturing method of the filter assembly according to the example of the present disclosure will be described.

The manufacturing method of the filter assembly according to the present disclosure may include manufacturing the filter case 100 having a structure in which the air inlet 101 and an the outlet 102 are formed, manufacturing the first filter support 110 having a structure in which a plurality of first support wings 111 and a plurality of first holding wings 112 are formed, and manufacturing the second filter support 120 having a structure in which a plurality of second support wings 121 and a plurality of second holding wings 122 are formed.

As described herein, the filter case 130 may be manufactured in a fan shape using a paper material having a predetermined thickness. An arc length of an outer diameter portion having the air inlet 131 formed therein may be larger than an arc length of an inner diameter portion having the air outlet 132 formed therein.

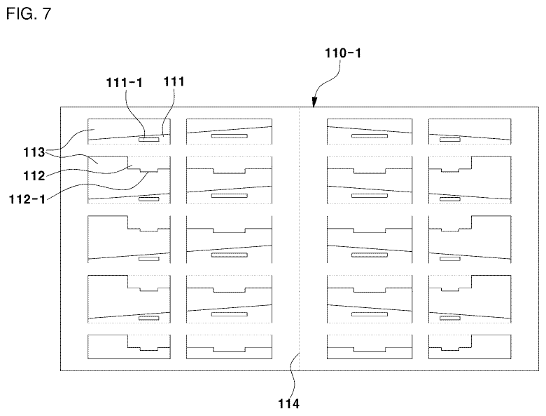

As shown in FIG. 7, manufacturing the first filter support 110 includes providing, using a paper material, a first plate 110-1 having a predetermined area and including a folding line 114 formed in a middle portion of the first plate 110-1, and forming, using a known punching machine (not shown), the same number of inlet air flow holes 113 in one area of the folding line 114 of the first plate 110-1 and the other area of the folding line 114.

The first support wing 111 (e.g., that remains in a state of being integrated with the lower side of the inflow air flow hole 113 when/if the punching machine is used to form the inflow air flow hole) may be folded in the outward direction (e.g., away from first filter support 110/first plate 110-1). For example, the first support wing 111 that is not perforated (e.g., by the punching machine used to form the inflow air flow hole), and remains in a state of being integrated with the lower side/edge of/around the inflow air flow hole 113, may be folded in the outward direction.

The first holding wing 112 (e.g., that remains in a state of being integrated with the upper side of the inflow air flow hole 113 if/when the punching machine is used to form the inflow air flow hole) may be folded in the outward direction. For example, the first holding wing 112, which is not perforated (e.g., by the punching machine used to form the inflow air flow hole), and remains in a state of being integrated with the upper side/edge of/around the inflow air flow hole 113, may be folded in the outward direction. The first holding wing 112 may be coupled to the first support wing 111, so as to maintain/support the first support wing 111 in the horizontal state.

If/when the punching machine is used to form the inflow air flow hole, the first holding protrusion 112-1 may be formed on the first holding wing 112, and the first coupling hole 111-1 may be formed in the first support wing 111. The first holding protrusion 112-1 may be inserted into and coupled to the first coupling hole 111-1. In this manner, the first support wing 111 may be fixedly maintained in the horizontal direction in a state of being supported by the first holding wing 112.

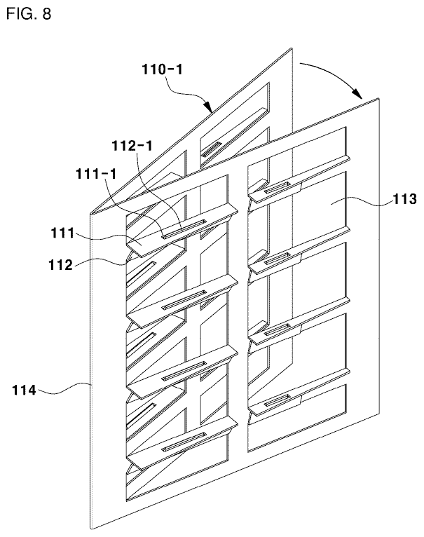

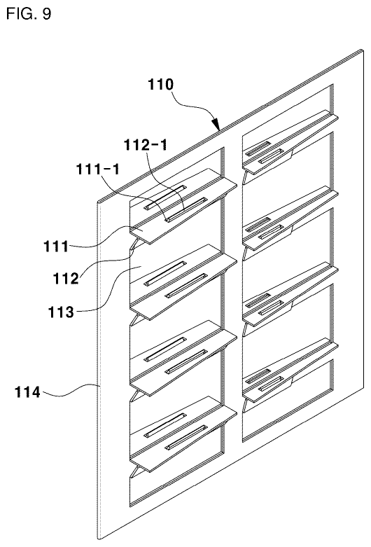

For example, as shown in FIG. 8, one side area and the other side area of the first plate 110-1 are folded along the folding line 114. Next, as shown in FIG. 9, one side area and the other side area of the first plate are bonded to each other with an adhesive, thereby completing the first filter support 110.

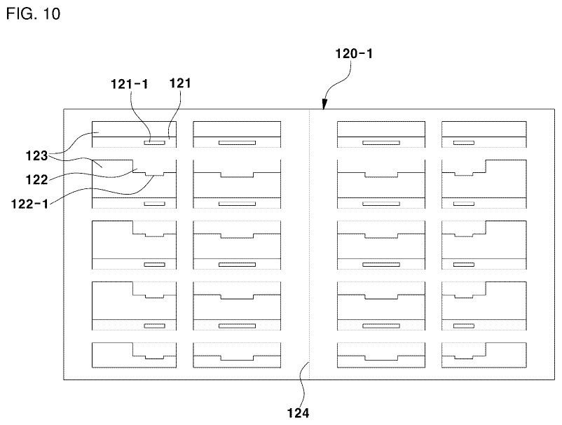

As shown in FIG. 10, for example, manufacturing the second filter support 120 may include providing, using a paper material, a second plate 120-1 having a predetermined area and including a folding line 124 in a middle portion of the second plate 120-1. Manufacturing the second filter support 120 may include forming, using a punching machine, a same number of exhaust air flow holes 123 in a first area of the folding line 124 of the second plate 120-1 and in a second area of the folding line 124.

The second support wing 121 (e.g., that remains in a state of being integrated with the lower side of the exhaust air flow hole 123 if/when the punching machine is used to form the exhaust air flow hole) may be folded in the outward direction) may be folded in the outward direction (e.g., from the second filter support/away from the second filter support). For example, the second support wing 121 (e.g., that is not perforated by the punching machine used to form the exhaust air flow hole), and remains in a state of being integrated with the lower side/edge of/around the exhaust air flow hole 123, may be folded in the outward direction.

The second holding wing 122 (e.g., that remains in a state of being integrated with the upper side of the exhaust air flow hole 123 if/when the punching machine is used to form the exhaust air flow hole) may be folded in the outward direction. For example, the second holding wing 122 (e.g., that is not perforated by the punching machine used to form the exhaust air flow hole), and remains in a state of being integrated with the upper side/edge of/around the exhaust air flow hole 123, may be folded in the outward direction. The second holding wing 122 may be coupled to the second support wing 121 so as to maintain the second support wing 121 in the horizontal state.

If/when the punching machine is used to form the exhaust air flow hole, the second holding protrusion 122-1 may be formed on the second holding wing 122, and the second coupling hole 121-1 may be formed in the second support wing 121. The second holding protrusion 122-1 may be inserted into and coupled to the second coupling hole 121-1. In this manner, the second support wing 121 may be fixedly maintained in the horizontal direction in a state of being supported by the second holding wing 122.

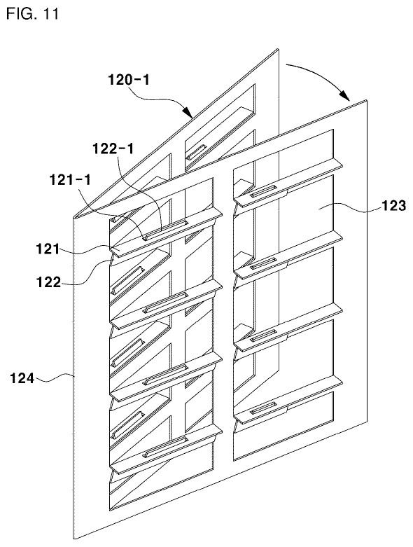

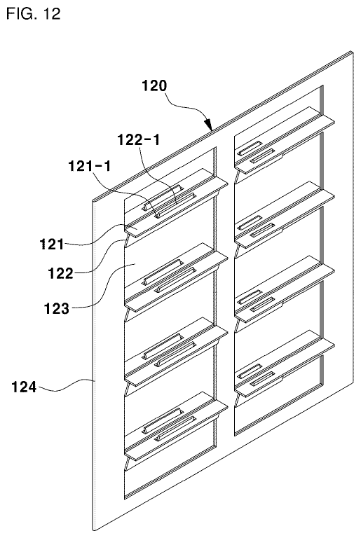

For example, as shown in FIG. 11, a first side area and a second side area of the second plate 120-1 may be formed by folding along the folding line 124. As shown in FIG. 12, for example, a first side area and a second side area of the second plate 120-1 may be bonded to each other (e.g., with an adhesive), thereby completing the second filter support 120.

For a plurality of first filter supports 110 and a plurality of second filter supports 120 (e.g., formed/structured as described herein), a part of the length section of the main filter 100 may be repeatedly folded/wound around the outer ends of the respective first filter supports 110. The part of the length sections may be closely (e.g., directly) supported by the first support wings 111. Another part of the length section of the main filter 100 may be repeatedly folded/wound around the inner ends of the respective second filter supports 120. Another part of the length section may be closely (e.g., directly) supported by the second support wings 121.

As disclosed herein, the main filter 100 may be arranged in a zigzag pattern using the first filter supports 110 and the second filter supports 120. The first support wings 111 of the first filter supports 110 may closely (e.g., directly) support the inner surface of the main filter 100, and the second support wings 121 of the second filter support 120 may closely (e.g., directly) support the outer surface of the main filter 100. The main filter 100 as disclosed herein may be reliably fixed so as to be configured to substantially filter out various types of contaminants (e.g., dust and paint aerosols).

The first support wings 111 may be formed to be integrated with both side surfaces of the first filter support 110, and each of the first support wings 111 may have a width that gradually narrows from the air inlet side toward the air outlet side. Accordingly, as shown in FIG. 3, the first open groove 100-1 having a “V” shape that is open at a predetermined angle may be formed in the inner surface of the main filter 100 by the first support wings 111.

Also, or alternatively, the second support wings 121 may be integrated with both side surfaces of the second filter support 120. Each of the second support wings 121 may be formed to have a constant width. As shown in FIG. 3, for example, the second open groove 100-2 having a constant width may be formed in the outer surface of the main filter 100 by the second support wings 121.

The main filter 100, the first filter support 110, and the second filter support 120 may be fixedly inserted into the inside of the filter case 130, thereby covering the upper and lower portions of the main filter 100, the first filter support 110, and the second filter support 120. Further, as shown in FIG. 4, the first open groove 100-1 in the main filter 100 may be exposed through/via the air inlet 131, and as shown in FIG. 5, the second open groove 100-2 in the main filter 100 may be exposed through/via the air outlet 132.

The main filter 100 as disclosed herein may be arranged in a zigzag pattern, the first support wings 111 of the first filter support 110 may closely (e.g., directly) support the inner surface of the main filter 100, and the second support wings 121 of the second filter support 120 may closely (e.g., directly) support the outer surface of the main filter 100, thereby reliably fixing the main filter 100 configured to filter out various types of contaminants (e.g., dust and paint aerosols within the filter case 130). Accordingly, a constant flow of filtered air passing through the main filter 100 may be secured, thereby improving performance of the paper filter configured to collect various types of contaminants (e.g., dust and paint aerosols).

The present disclosure has been made in an effort to solve the above-described problems associated with the prior art, and it is an aspect of the present disclosure to provide a filter assembly configured to reliably fix, using a plurality of filter supports, a main filter configured to substantially filter out various types of dust and paint aerosols, thereby preventing occurrence of a local pressure difference in a paper filter, enabling a constant flow of air passing through the paper filter, and improving performance of the paper filter configured to collect various types of dust and paint aerosols.

In one aspect, the present disclosure provides a filter assembly including a main filter having a plurality of first open grooves formed to face inwards and a plurality of second open grooves formed to face outwards, the first open grooves and the second open grooves being alternately arranged, a first filter support disposed in each of the first open grooves, the first filter support having a plurality of first support wings formed thereon and configured to closely support an inner surface of the main filter, a second filter support disposed in each of the second open grooves, the second filter support having a plurality of second support wings formed thereon and configured to closely support an outer surface of the main filter, and a filter case formed to have a structure including an air inlet and an air outlet, the filter case being configured to cover upper and lower portions of the main filter, the first filter support, and the second filter support.

In an example, the main filter may be arranged in a zigzag pattern by repeatedly winding a part of a length section of the main filter around an outer end of the first filter support and repeatedly winding another part of the length section of the main filter around an inner end of the second filter support, thereby alternately forming the first open grooves and the second open grooves.

In another example, the main filter main may be formed of a first-stage filter, a second-stage filter, and a third-stage filter having different mesh sizes, the first-stage filter, the second-stage filter, and the third-stage filter being stacked on and attached to each other.

In still another example, the first support wings may be formed to be integrated with both side surfaces of the first filter support, each of the first support wings having a width formed to gradually narrow from the air inlet to the air outlet, and ends of the first support wings may closely support inner wall surfaces of the first open grooves, the inner wall surfaces being a part of the inner surface of the main filter.

In yet another example, the first filter support may have first holding wings further formed on the both side surfaces of the first filter support and disposed below the respective first support wings, the first holding wings being configured to support the respective first support wings, and the first holding wings may have first support protrusions formed thereon, the first support protrusions being inserted into and coupled to first coupling holes formed in the respective first support wings.

In still yet another example, each of the first open grooves may be formed to have a “V” shape open at a predetermined angle inwards by the first support wings each having a width formed to gradually narrow from the air inlet to the air outlet.

In a further example, a plurality of inflow air flow holes may be formed at upper positions of the first support wings of the first filter support and lower positions of the first holding wings of the first filter support.

In another further example, the second support wings may be formed to be integrated with both side surfaces of the second filter support, each of the second support wings having a constant width, and ends of the second support wings may closely support an inner wall surface of the second open grooves, the inner wall surface being a part of the outer surface of the main filter.

In still another further example, the second filter support may have second holding wings further formed on the both side surfaces of the second filter support and disposed below the respective second support wings, the second holding wings being configured to support the respective second support wings, and the second holding wings may have second support protrusions formed thereon, the second support protrusions being inserted into and coupled to second coupling holes formed in the respective second support wings.

In yet another further example, each of the second open grooves may be formed to have a constant width by the second support wings each having the constant width.

In still yet another further example, a plurality of exhaust air flow holes may be formed at upper positions of the second support wings of the second filter support and lower positions of the second holding wings of the second filter support.

In a still further example, the filter case may be formed to have a fan-shaped box structure configured such that an arc length of an outer diameter portion having the air inlet formed therein is larger than an arc length of an inner diameter portion having the air outlet formed therein.

In another aspect, the present disclosure provides a manufacturing method of a filter assembly, the manufacturing method including manufacturing a filter case formed to have a structure including an air inlet and an air outlet, manufacturing a first filter support formed to have a structure including a plurality of first support wings and a plurality of first holding wings, manufacturing a second filter support formed to have a structure including a plurality of second support wings and a plurality of second holding wings, repeatedly winding a part of a length section of the main filter around an outer end of the first filter support and closely supporting, using the first support wings, the part of the length section, repeatedly winding another part of the length section of the main filter around an inner end of the second filter support and closely supporting, using the second support wings, the other part of the length section, and fixedly inserting the main filter, the first filter support, and the second filter support into an inside of the filter case so as to cover upper and lower portions of the main filter, the first filter support, and the second filter support.

In an example, the filter case may be manufactured using a paper material and may be formed to have a fan-shaped box structure configured such that an arc length of an outer diameter portion having the air inlet formed therein is larger than an arc length of an inner diameter portion having the air outlet formed therein.

In another example, the manufacturing of the first filter support may include providing a first plate having a predetermined area, the first plate having a folding line formed along a middle portion thereof, forming, by a punching machine, the same number of inlet air flow holes in one side area of the folding line of the first plate and the other side area of the folding line of the first plate, folding, in an outward direction, the first support wings remaining integrated with lower sides of the inlet air flow holes during formation of the inlet air flow holes by the punching machine so as to closely support the main filter, folding, in the outward direction, the first holding wings remaining integrated with upper sides of the inlet air flow holes during the formation of the inlet air flow holes by the punching machine and then coupling the first holding wings to the respective first support wings so as to support the first support wings, and folding the one side area and the other side area of the first plate along the folding line and then bonding the one side area and the other side area to each other with an adhesive.

In still another example, the first support wings may be formed to be integrated with both side surfaces of the first filter support, each of the first support wings having a width formed to gradually narrow from the air inlet to the air outlet, and a first open groove having a “V” shape open at a predetermined angle may be formed in an inner surface of the main filter by the first support wings.

In yet another example, in the coupling of the first holding wings to the respective first support wings, first support protrusions formed on the first holding wings may be inserted into and coupled to first coupling holes formed in the respective first support wings.

In still yet another example, the manufacturing of the second filter support may include providing a second plate having a predetermined area, the second plate having a folding line formed along a middle portion thereof, forming, by a punching machine, the same number of exhaust air flow holes in one side area of the folding line of the second plate and the other side area of the folding line of the second plate, folding, in an outward direction, the second support wings remaining integrated with lower sides of the exhaust air flow holes during formation of the exhaust air flow holes by the punching machine so as to closely support the main filter, folding, in the outward direction, the second holding wings remaining integrated with upper sides of the exhaust air flow holes during the formation of the exhaust air flow holes by the punching machine and then coupling the second holding wings to the respective second support wings so as to support the second support wings, and folding the one side area and the other side area of the second plate along the folding line and then bonding the one side area and the other side area to each other with an adhesive.

In a further example, the second support wings may be formed to be integrated with both side surfaces of the second filter support, each of the second support wings having a constant width, and a second open groove having a constant width may be formed in an outer surface of the main filter by the second support wings.

In another further example, in the coupling the second holding wings to the respective second support wings, second support protrusions formed on the second holding wings may be inserted into and coupled to second coupling holes formed in the respective second support wings.

As is apparent from the above description, the present disclosure provides at least the following effects.

First, a main filter may be arranged in a zigzag pattern using a first filter support and a second filter support, and a plurality of support wings formed on the first filter support and the second filter support may closely support both side surfaces of the main filter, thereby reliably fixing the main filter of a paper filter, which substantially filters out various types of dust and paint aerosols. Accordingly, the occurrence of a local differential pressure in the paper filter may be prevented, and a constant flow of air to be filtered passing through the main filter may be maintained.

Second, the flow of air passing through the main filter of the filter assembly may be constantly maintained, thereby improving performance of the paper filter configured to collect various types of dust and paint aerosols.

Third, various types of dust and paint aerosols filtered by the main filter of the filter assembly may be evenly distributed and accumulated on a plurality of support wings formed on the first filter support and the second filter support, thereby preventing various types of dust and paint aerosols from being significantly accumulated on the lower portion of the paper filter. As a result, filtering performance of the paper filter may be improved, and the life of the paper filter may be extended.

Although the present disclosure has been described in detail with reference to one example, the scope of the present disclosure is not limited to the above-described example, and various modifications and improvements made by those skilled in the art using the basic concept of the present disclosure defined in the following claims also fall within the scope of the present disclosure.

What is claimed is:

1. A filter assembly comprising:
a main filter forming a plurality of first open grooves formed to face a first direction and a plurality of second open grooves formed to face a second direction opposite to the first direction, the first open grooves and the second open grooves being alternately arranged;
a plurality of first filter supports, wherein each first filter support of the plurality of first filter supports is disposed in a corresponding one of the first open grooves and comprises a plurality of first support wings configured to support a first surface of the main filter;
a plurality of second filter supports, wherein each second filter support of the plurality of second filter supports is disposed in a corresponding one of the second open grooves and comprises a plurality of second support wings configured to support a second surface of the main filter; and
a filter case, forming an air inlet and an air outlet, the filter case being configured to cover upper and lower portions of:
the main filter,
the first filter support, and
the second filter support.

2. The filter assembly of claim 1, wherein the first surface of the main filter is an inner surface of the main filter, wherein the second surface of the main filter is an outer surface of the main filter, wherein the main filter is arranged in a zigzag pattern, and wherein at least a first part of a length section of the main filter is wound around outer ends, of the first filter supports, in the second direction, at least a second part of the length section of the main filter is wound around inner ends, of the second filter supports, in the first direction, such that the first open grooves and the second open grooves alternate.

3. The filter assembly of claim 1, wherein the main filter comprises a first-stage filter, a second-stage filter, and a third-stage filter,
wherein the first-stage filter, the second-stage filter, and the third-stage filter each having different mesh sizes, and
wherein the first-stage filter, the second-stage filter, and the third-stage filter are stacked on and attached to each other.

4. The filter assembly of claim 1, wherein:
each first filter support, of the plurality of first filter supports, comprises two sides opposite to each other,
each side of the two sides of each first filter support comprises a first support wing, of the plurality of first support wings,
each of the first support wings has a width that narrows from the air inlet to the air outlet, and
edges of the first support wings support inner wall surfaces, of the first open grooves, that form a part of the first surface of the main filter.

5. The filter assembly of claim 4, wherein:
each side of the two sides of each first filter support comprises a first holding wing disposed below a corresponding first support wing,
each of the first holding wings is configured to support the corresponding first support wing, and
each of the first holding wings comprises a first support protrusion configured to be inserted into and coupled to a first coupling hole formed in the corresponding first support wing.

6. The filter assembly of claim 5, wherein a plurality of inflow air flow holes are formed in each of the first filter supports, wherein each of the first support wings is formed at a lower edge of a corresponding inflow air flow hole, and each of the first holding wings is formed at an upper edge of a corresponding inflow air flow hole.

7. The filter assembly of claim 4, wherein each first open groove, of the plurality of first open grooves has a “V” shape that opens at a predetermined angle in the first direction, wherein the predetermined angle is defined by the width, of the first support wings, that narrows from the air inlet to the air outlet.

8. The filter assembly of claim 1, wherein:
each second filter support, of the plurality of second filter supports, comprises two sides opposite to each other,
each side of the two sides of each second filter support comprises a second support wing, of the plurality of second support wings,
each of the second support wings has a constant width, and
edges of the second support wings support inner wall surfaces, of the second open grooves, that form a part of the second surface of the main filter.

9. The filter assembly of claim 8, wherein:
each side of the two sides of each second filter support comprises a second holding wing disposed below a corresponding second support wing,
each of the second holding wings is configured to support the corresponding second support wing, and
each of the second holding wings comprises a second support protrusion configured to be inserted into and coupled to a second coupling hole formed in the corresponding second support wing.

10. The filter assembly of claim 9, wherein a plurality of exhaust air flow holes is formed in each of the second filter supports, wherein each of the second support wings is formed at a lower edge of a corresponding exhaust air flow hole, and each of the second holding wings is formed at an upper edge of a corresponding exhaust air flow.

11. The filter assembly of claim 8, wherein each of the second open grooves has a constant width based on the constant width of the second support wings.

12. The filter assembly of claim 1, wherein the filter case is formed to have a fan-shaped box structure comprising an outer diameter portion that forms the air inlet and an inner diameter portion that forms the air outlet, wherein an arc length of the outer diameter portion is greater than an arc length of the inner diameter portion.

13. A method of providing a filter assembly, the method comprising:
providing a filter case that forms an air inlet and an air outlet;
providing a plurality of first filter supports, wherein each first filter support of the plurality of first filter supports comprises a plurality of first support wings and a plurality of first holding wings configured to support the plurality of first support wings;
providing a plurality of second filter supports, wherein each second filter support of the plurality of second filter supports comprises a plurality of second support wings and a plurality of second holding wings configured to support the plurality of second support wings;
winding a first part of a length section of a main filter around first ends, of the plurality of first filter supports, in a first direction, such that the first support wings support the first part of the length section;
winding a second part of the length section of the main filter around second ends, of the plurality of second filter supports, in a second direction opposite to the first direction, such that the second support wings support the second part of the length section; and
inserting the main filter, wound around the first filter support and the second filter support, into the filter case, such that the filter case covers upper and lower portions of:
the main filter,
the first filter support, and
the second filter support.

14. The method of claim 13, wherein the filter case comprises a paper material and has a fan-shaped box structure comprising an outer diameter portion that forms the air inlet and an inner diameter portion that forms the air outlet, wherein an arc length of the outer diameter portion is greater than an arc length of the inner diameter portion.

15. The method of claim 13, wherein the providing of the first filter support comprises:
providing a first plate having a predetermined area, the first plate having a folding line formed along a middle portion of the first plate;
forming a same number of inflow air flow holes in a first side area of the first plate to a first side of the folding line and in a second side area of the first plate to a second side of the folding line opposite to the first side, wherein each of the first support wings is formed at a lower edge of a corresponding inflow air flow hole, and each of the first holding wings is formed at an upper edge of a corresponding inflow air flow hole;
folding, in an outward direction, the first support wings remaining integrated with lower edges of the inflow air flow holes;
folding, in the outward direction, the first holding wings remaining integrated with upper edges of the inflow air flow holes coupling the first holding wings to the corresponding first support wings such that the first holding wings support the first support wings;
folding the first plate along the folding line in an inward direction opposite to the outward direction; and
bonding the first side area and the second side area to each other with an adhesive.

16. The method of claim 15, wherein each of the first support wings has a width that narrows from the air inlet to the air outlet, such that the winding the first part of the length section of the main filter around the first ends of the plurality of first filter supports forms a plurality of first open grooves each having a “V” shape opened at a predetermined angle in the second direction based on the width of the plurality of the first support wings.

17. The method of claim 16, wherein the coupling of the first holding wings to the first support wings comprises inserting first support protrusions formed on the first holding wings into first coupling holes each formed in a corresponding one of the first support wings.

18. The method of claim 13, wherein the providing of the second filter support comprises:
providing a second plate having a predetermined area, the second plate having a folding line formed along a middle portion of the second plate;
forming a same number of exhaust air flow holes in a first side area of the second plate to a first side of the folding line and in a second side area of the second plate to a second side of the folding line opposite to the first side, wherein each of the second support wings is formed at a upper side of a corresponding exhaust air flow hole, and each of the second holding wings is formed at an lower side of a corresponding exhaust air flow hole;
folding, in an outward direction, the second support wings remaining integrated with lower edges of the exhaust air flow holes;
folding, in the outward direction, the second holding wings remaining integrated with upper edges of the exhaust air flow holes;
coupling the second holding wings to the corresponding second support wings such that the second holding wings support the second support wings;
folding the first side area and the second side area of the second plate along the folding line; and
bonding the first side area and the second side area to each other with an adhesive.

19. The method of claim 18, wherein each of the second support wings has a constant width, such that the winding the second part of the length section of the main filter around the second ends of the plurality of the second filter supports form a plurality of second open grooves each open in the first direction and having a constant width based on the constant width of the plurality of the second support wings.

20. The method of claim 18, wherein the coupling of the second holding wings to the second support wings comprises inserting second support protrusions formed on the second holding wings into second coupling holes each formed in a corresponding one of the second support wings.
